(19) United States
(12) Patent Application Publication
(10) Pub. No.: US 2023/0246297 A1
(43) Pub. Date: Aug. 3, 2023

(54) LITHIUM BATTERY SEPARATOR INCLUDING POROUS PVDF-BASED RESIN COATING AND PREPARATION METHOD THEREFOR

(71) Applicant: SINOMA LITHIUM BATTERY SEPARATOR CO., LTD., Zaozhuang, Shandong (CN)

(72) Inventors: Yaozong BAI, Zaozhuang, Shandong (CN); Pingchuan MA, Zaozhuang, Shandong (CN); Gaojun LIU, Zaozhuang, Shandong (CN); Feifei GAO, Zaozhuang, Shandong (CN); Jingran DU, Zaozhuang, Shandong (CN); Xujie ZHANG, Zaozhuang, Shandong (CN); Yang ZHOU, Zaozhuang, Shandong (CN); Mengmeng ZHAI, Zaozhuang, Shandong (CN); Chao HAN, Zaozhuang, Shandong (CN); Ming WEI, Zaozhuang, Shandong (CN); Sen ZHANG, Zaozhuang, Shandong (CN); Yuan SUN, Zaozhuang, Shandong (CN)

(73) Assignee: SINOMA LITHIUM BATTERY SEPARATOR CO., LTD., Zaozhuang, Shandong (CN)

(21) Appl. No.: 18/024,048

(22) PCT Filed: Dec. 31, 2021
(86) PCT No.: PCT/CN2021/143846

§ 371 Date: Feb. 28, 2023

(30) Foreign Application Priority Data
Dec. 30, 2021 (CN) 202111635856.2

(51) Int. Cl. H01M 50/446; H01M 50/491; H01M 50/403; H01M 10/052; H01M 50/426; H01M 50/417; H01M 50/457

(52) U.S. Cl. CPC H01M 50/446; H01M 50/491; H01M 50/403; H01M 10/052; H01M 50/426; H01M 50/417; H01M 50/457

(57) ABSTRACT

Disclosed is a lithium battery separator including a porous PVDF-based resin coating, wherein the porous PVDF-based resin coating is located on at least one surface of a base film, and the porous PVDF-based resin coating on a single side has a thickness of 0.5-3.5 μm, and has a ratio of a bonding strength (N/m) to coating air permeability increment (s/100 cc) of greater than or equal to 0.25, and a ratio of a bonding strength (N/m) to a surface density per unit coating (g/m²/μm) of greater than or equal to 10, resulting in a porous PVDF-based resin coating with excellent thickness, coating air permeability increment, bonding strength and thermal shrinkage; and the formed lithium battery separator is also excellent in cycling performance and heat resistance.

### CROSS-REFERENCE TO RELATED APPLICATIONS

The present disclosure claims the priority of Chinese Patent Application No. 2021116358562, entitled “Lithium Battery Separator Including Porous PVDF-based Resin Coating and Preparation Method Therefor”, and filed to the China National Intellectual Property Administration on Dec. 30, 2021, the entire contents of which are incorporated herein by reference.

### FIELD

The present disclosure relates to lithium battery separators and lithium batteries, and in particular, relates to a lithium battery separator including a porous PVDF-based resin coating and a lithium battery including the same.

### BACKGROUND

In lithium batteries, a separator is mainly used to separate a positive electrode from a negative electrode of a battery to prevent a short circuit due to contact of the two electrodes. In addition, the separator has a function of allowing electrolyte ions to pass through. Polyvinylidene fluoride (PVDF) based resins are generally used as an adhesive layer in the prior art from the viewpoint of thermal stability, easy formation of a porous adhesive coating and electrolyte wettability. In order to increase a unit energy density of the lithium battery, it is generally desirable that the thickness of the separator is as thin as possible. Further, in order to increase the bonding of the separator to positive and negative electrode active materials, there are higher requirements for the type and thickness of the adhesive layer, and in combination with requirements for ionic conductivity, thermal shrinkage, and mechanical strength of the separator, how to further design the adhesive layer of polyvinylidene fluoride (PVDF) based resins is particularly critical.

### SUMMARY

Thus far, there is no concern in the prior art on how to take into account the coating thickness, bonding strength, thermal shrinkage, and ionic conductivity performances of a lithium battery separator including a porous PVDF-based resin coating to improve the use performance of a lithium battery.

In view of this technical problem, the inventors, after systematic research, finally found that when a ratio of a bonding strength to coating air permeability increment and a ratio of a bonding strength to a surface density per unit thickness are limited to a specific range, a porous PVDF-based resin coating with excellent thickness, coating air permeability increment, bonding strength, and thermal shrinkage can be obtained, and the formed lithium battery separator is also excellent in cycle performance and heat resistance. Specific technical solutions of the present disclosure are as follows:

1. a lithium battery separator including a porous PVDF-based resin coating, wherein the porous PVDF-based resin coating is located on at least one surface of a base film, and the porous PVDF-based resin coating on a single side has a thickness of 0.5-3.5 μm, has a ratio of a bonding strength (N/m) to coating air permeability increment (s/100 cc) of greater than or equal to 0.25, and a ratio of a bonding strength (N/m) to a surface density per unit coating (g/m²/μm) of greater than or equal to 10.

2. The lithium battery separator according to the technical solution 1, wherein PVDF-based resin in the porous PVDF-based resin coating includes high molecular weight PVDF and low molecular weight PVDF, wherein the high molecular weight PVDF has a weight average molecular weight of 800,000-1,200,000, the low molecular weight PVDF has a weight average molecular weight of 200,000-500,000, and a weight ratio of the high molecular weight PVDF to the low molecular weight PVDF is 7:1 to 1:7.

3. The lithium battery separator according to one of the technical solutions 1 and 2, wherein the porous PVDF-based resin coating further includes inorganic particles, and the content of the inorganic particles is 40-80 wt % based on a total weight of the porous PVDF-based resin coating.

4. The lithium battery separator according to one of the technical solutions 1-3, wherein the water content of its slurry is less than 5 wt % during preparation of the porous PVDF-based resin coating.

5. The lithium battery separator according to one of the technical solutions 1-4, wherein the water content of a coagulating bath is 30 wt %-70 wt % during preparation of the porous PVDF-based resin coating.

6. The lithium battery separator according to one of the technical solutions 1-5, wherein drying is carried out at a temperature of 60-100° C. during preparation of the porous PVDF-based resin coating.

7. A preparation method for a lithium battery separator including a porous PVDF-based resin coating, including the specific steps of:

step 1: dispersing PVDF-based resin and optionally inorganic particles into a solvent to form a coatable slurry, wherein the solvent includes a good solvent, and the water content of the slurry on the whole is less than 5 wt %; and

step 2: coating at least one surface of a base film with the coatable slurry, dipping in a coagulating bath at room temperature for solidifying the resulting coating to form the porous PVDF-based resin coating, cleaning, and drying to obtain the lithium battery separator;

wherein the water content of the coagulating bath is 30 wt %-70 wt %, and the drying is carried out at a temperature of 60° C.-100° C.

8. The preparation method according to the technical solution 7, wherein the PVDF-based resin includes high molecular weight PVDF and low molecular weight PVDF, wherein the high molecular weight PVDF has a weight average molecular weight of 800,000-1,200,000, the low molecular weight PVDF has a weight average molecular weight of 200,000-500,000, and a weight ratio of the high molecular weight PVDF to the low molecular weight PVDF is 7:1 to 1:7.

9. The preparation method according to the technical solution 7, wherein the content of the inorganic particles is 40-80 wt % based on a total weight of the porous PVDF-based resin coating.

10. A lithium battery, including a positive electrode, a negative electrode, a non-aqueous electrolyte, and the lithium battery separator according to one of the technical solutions 1-6 or the lithium battery separator obtained by the method according to one of the technical solutions 7-9.

The present disclosure has beneficial effects as follows:

the lithium battery separator including the porous PVDF-based resin coating obtained according to the present disclosure has excellent bonding performance to positive electrodes, high temperature dimensional stability, and good air permeability, so that the finally formed lithium battery has high energy density and excellent cycling performance, thereby solving the technical problem in the prior art that the bonding strength and ionic conductivity of the separator cannot be taken into account simultaneously.

### BRIEF DESCRIPTION OF THE DRAWINGS

FIG. 1 illustrates an SEM image showing an apparent morphology of a lithium battery separator including a porous PVDF-based resin coating in Example 2.

FIG. 2 illustrates an SEM image showing an apparent cross-section of the lithium battery separator including the porous PVDF-based resin coating in Example 2.

FIG. 3 illustrates an SEM image showing an apparent morphology of a lithium battery separator including a porous PVDF-based resin coating in Example 12.

### DETAILED DESCRIPTION OF THE EMBODIMENTS

In order to better interpret the present disclosure, reference is made to embodiments of the present disclosure to describe the present disclosure in detail, and the main contents of the present disclosure are further illustrated in conjunction with specific examples. However, the contents of the present disclosure are not limited to the following examples. Where specific techniques or conditions are not indicated in the examples, the techniques or conditions are performed according to the techniques or conditions described in the literatures in the prior art or in accordance with the product specifications. The reagents or instruments used, without any indication of the manufacturer, are a conventional product commercially available.

Base Film

The base film is generally a polyolefin porous base film, or may be selected from conventional polyolefin porous base films suitable for lithium battery separators, including one or more copolymers or more blends selected from polyethylene, polypropylene, polybutene, and poly(4-methylpentene).

From the viewpoint of exhibiting a closing function, a polyolefin microporous film preferably includes polyethylene, and the content of polyethylene is preferably 95% by mass or more of the total content of the base film.

In one embodiment, the polyolefin porous base film is a monolayer polyolefin microporous film. In another embodiment, the polyolefin porous base film is a polyolefin microporous film having a laminated structure of two or more layers.

Polyolefin contained in the polyolefin porous base film preferably has a weight average molecular weight (Mw) of 100,000 to 5,000,000. When the weight average molecular weight is 100,000 or more, the well mechanical property can be ensured. On the other hand, when the weight average molecular weight is 5,000,000 or less, polyolefin has the good closing property, and is easy for film formation.

The thickness of the polyolefin porous base film is not particularly limited, and is preferably 5 μm to 30 μm. The polyolefin porous base film is a porous polymer film formed mainly by stretching.

A method of manufacturing the polyolefin porous base film according to exemplary embodiments of the present disclosure is not limited, provided that the polyolefin porous base film is manufactured by a person skilled in the art. In an exemplary embodiment, the polyolefin porous base film can be manufactured by a dry or wet process. The dry process is a process of forming a polyolefin film, and then stretching the film at a low temperature to form micropores. However, the stretching may cause microcracks in crystalline flakes of polyolefin. The wet process is a process of mixing polyolefin-based resin and a diluent at a high temperature at which the polyolefin-based resin is melted to form a single phase, subjecting the polyolefin and the diluent to phase separation during cooling, and then extracting the diluent to form pores therein. The wet process is a process of imparting mechanical strength and transparency by the stretching/extraction process after phase separation. Compared with the dry process, a film formed by the wet process has small thickness, uniform pore size, and excellent physical properties. Therefore, the wet process is more preferred.

From the viewpoint of appropriate film resistance and closing function, a porous substrate preferably has a porosity of 20% to 60% and an average pore size of 15 nm to 100 nm.

From the viewpoint of improving the manufacturing yield, a puncture strength of the polyolefin porous base film is preferably 200 g or more.

Porous PVDF-Based Resin Coating

In the present disclosure, the porous PVDF-based resin coating is used as an adhesive layer, wherein the PVDF-based resin is present in an amount of 90 wt % or more, or 95 wt % or more, or 99 wt % or more, based on all adhesive resins. The PVDF-based resin specifically includes a vinylidene fluoride homopolymer, a copolymer of vinylidene fluoride with other copolymerizable monomers, or a mixture thereof. Specific examples of monomers copolymerizable with vinylidene fluoride may include at least one selected from the group consisting of: tetrafluoroethylene, hexafluoropropylene, trifluoroethylene, chlorofluoroethylene, 1,2-difluoroethylene, perfluoro(methylvinyl) ether, perfluoro(ethylvinyl) ether, perfluoro(propylvinyl) ether, difluoro(1,3-dioxole), perfluoro(2,2-dimethyl-1,3-dioxole), trichloroethylene, and fluoroethylene.

Control of the molecular weight of the PVDF-based resin will affect the bonding property, pore-forming property, and dimensional stability performance of the PVDF resin. The PVDF-based resin thus includes a first high molecular weight PVDF resin and a second low molecular weight PVDF resin. The high molecular weight PVDF has a weight average molecular weight of 800,000-1,200,000, the low molecular weight PVDF has a weight average molecular weight of 200,000-500,000, and a weight ratio of the high molecular weight PVDF to the low molecular weight PVDF is 7:1 to 1:7. Based on the final effect, the first high molecular weight PVDF resin may have a significant contribution to bonding of inorganic particles to prevent de-embedding and dimensional stability, and the second low molecular weight PVDF resin may have an impact on film forming properties, pore-forming properties, and interfacial adhesion.

Preferably, the porous PVDF-based resin coating further includes inorganic particles, which may be selected from any inorganic fillers that are stable with respect to electrolytes and electrochemically stable, and in particular may be selected from one or more of the following materials:

an oxide ceramic-based material, including alumina, silica, titania, zirconia, magnesia, ceria, titania, zinc oxide, and iron oxide;

a nitride-based material, including silicon nitride, titanium nitride, and boron nitride;

a metal hydroxide-based material, including aluminum hydroxide, magnesium hydroxide, calcium hydroxide, chromium hydroxide, zirconium hydroxide, cerium hydroxide, and nickel hydroxide; and

boehmite, magnesium carbonate, magnesium sulfate, barium sulfate, calcium carbonate, wollastonite, silicon carbide, and the like, wherein alumina or boehmite is preferred.

The content of the inorganic particles is 40-80 wt %, further preferably 50-75 wt %, and more preferably 60-70 wt % based on the total weight of the porous PVDF-based resin coating.

Slurry

In order to obtain the porous PVDF-based resin coating, a coatable slurry needs to be prepared first from the PVDF-based resin, optionally inorganic particles, and a good solvent. Examples of the good solvent include acetone, methyl ethyl ketone, N-methyl pyrrolidone, and polar amide solvents such as dimethyl acetamide, diethyl formamide, and diethyl formamide. Water in the slurry as a poor solvent for phase separation is not essential, and in fact the water content in the slurry on the whole is preferably 5 wt % or less.

From the viewpoint of forming a good porous structure, the content of the PVDF-based resin and the content of the inorganic particles in the slurry are preferably 6 wt % to 20 wt %, preferably 8 wt % to 15 wt %, and the balance is the good solvent.

Coating Method

The coatable slurry first coats at least one surface of the base film. Preferably, the coatable slurry coats the above porous substrate by dip coating, air knife coating, curtain coating, roll coating, wire rod coating, photogravure coating, mold coating, or the like, to form a coating film. Among these coating methods, the photogravure coating or the mold coating is preferred as the coating method of the above coating liquid.

The base film coated with the slurry is treated with a coagulating liquid capable of solidifying the PVDF resin. Thus, the PVDF porous resin is solidified to form a porous PVDF resin layer. Examples of a method of treating with the coagulating liquid include a method of spraying the coagulating liquid on a substrate coated with the slurry for coating, a method of dipping the substrate in a bath in which the coagulating liquid is added (a coagulating bath), and the like. The coagulating liquid is not particularly limited, provided that the coagulating liquid is a liquid capable of solidifying the PVDF resin, preferably water, or preferably a solution obtained by mixing an appropriate amount of water with a solvent used for the slurry. The content of water in the coagulating bath is 30 wt %-70 wt %, preferably 35 wt %-65 wt %, further preferably 40 wt %-60 wt %. The temperature of the coagulating bath is room temperature.

Then, the lithium battery separator including the porous PVDF-based resin coating and treated with the coagulating bath is dried. As for the drying conditions, the air speed and drying temperature are not particularly limited, provided that the base film does not shrink due to softening, and the PVDF resin and the inorganic particles can be sufficiently bonded. Examples of the drying process include heat transfer drying (adhesion to a high-heat object), convective heat transfer (hot air), radiative heat transfer (infrared ray), and other methods (microwave, induction heating, etc.). Among the above manufacturing methods, convective heat transfer or radiative heat transfer is preferred because of the need to have a precise and uniform drying speed in a width direction. In addition, in order to achieve the uniform drying speed in the width direction during constant-rate drying, it is preferred to use a method that can reduce the total mass transfer coefficient during drying while maintaining a controlled wind speed, in the case that the convective heat transfer drying is used. Specifically, hot air is transported in a direction parallel to a support substrate, and parallel to or perpendicular to a transport direction of the substrate. The drying temperature is preferably controlled at 60° C.-100° C., preferably 70° C.-90° C., more preferably 75° C.-85° C.

With different examples, it is found that different water contents of the coagulating bath and different drying temperatures have an effect on the air permeability increment and bonding strength of the coating.

Lithium Battery

The lithium battery of the present disclosure has a positive electrode, a negative electrode, an electrolyte, and a separator disposed between the positive electrode and the negative electrode according to the present disclosure. Specifically, the lithium battery is of a structure in which a battery element and the electrolyte are encapsulated together into an external packaging material, and the battery element is obtained by oppositely positioning the negative electrode and the positive electrode across the separator.

The positive electrode is, for example, of a structure obtained by molding an active material layer containing a positive electrode active material and a binder resin on a current collector.

Examples of the positive electrode active material include conventional positive active materials in the art, for example, a lithium-containing transition metal oxide, and specifically, LiCoO₂, LiNiO₂, LiMn_{1/2}Ni_{1/2}O₂, LiCo_{1/3}Mn_{1/3}N_{1/3}O₂, LiMn₂O₄, LiFePO₄, LiCO_{1/2}Ni_{1/2}O₂, and LiA_{1/4}Ni_{3/4}O₂. Examples of the binder resin include polyvinylidene fluoride-based resin, a styrene-butadiene copolymer, and the like. A conductive auxiliary may also be contained. Examples of the conductive auxiliary include carbon materials such as acetylene black, Ketjen black, and graphite powder. Examples of the current collector include an aluminum foil, a titanium foil, and a stainless steel foil which have a thickness of 5 μm-20 μm.

Examples of the negative electrode include a structure obtained by molding an active material layer including a negative electrode active material and a binder resin on a current collector. The active material layer may further include a conductive auxiliary. Examples of the negative electrode active material include materials capable of absorbing lithium electrochemically. Specifically, examples of the negative electrode active material include carbon materials; alloys of silicon, tin, aluminum, and the like with lithium; Wood's alloys; and the like. The binder resin, the conductive auxiliary, and the current collector are substantially the same as those of the positive electrode portion. In addition, a metal lithium foil may be used as the negative electrode instead of the above negative electrode.

The electrolyte is a solution obtained by dissolving a lithium salt in a non-aqueous solvent. Examples of the electrolyte may be common electrolyte systems in the art. Examples of the lithium salt include LiPF₆, LiBF₄, LiClO₄, and the like. Examples of the non-aqueous solvent include cyclic carbonates such as ethylene carbonate, propylene carbonate, ethylene fluorocarbonate, ethylene difluorocarbonate, and vinylene carbonate; chain carbonates such as dimethyl carbonate, diethyl carbonate, methyl ethyl carbonate, vinyl carbonate and fluorine derivatives thereof; cyclic esters such as gamma-butyrolactone, gamma-valerolactone, and the like, which can be used alone or in combination.

### EXAMPLES

Hereinafter, the separator and a lithium secondary battery including the separator described in the present disclosure will be described more specifically by the examples. However, the embodiments of the present disclosure are not limited to the following examples.

<Evaluation Method>

(1) Film Thickness

A micrometer was used to measure the thickness of a separation base film, and then to measure the thickness of the coated base film, which subtracted the thickness of the separation base film to obtain the thickness of the porous coating.

(2) Average Particle Size

A particle size was measured by using a particle size measuring device (MicrotracUPA150, NIKKISO Co., LTD.). The measurement conditions were set as a load index of 0.15-0.3 and the measurement time of 300 seconds, and a particle size value of 50% of the obtained data was recorded as the particle size.

(3) Average Pore Size of Base Film

The pore size distribution of a porous film was measured by using a AAQ-3K-A-1 water-squeezing porosimeter of Porous Material Inc, USA. Water was used as a test solution. Water was squeezed into pore channels of the film under pressure, and the corresponding pressure of water squeezed into different pore sizes followed the Washburn equation. Thus, a series of pore structure parameters of the film were calculated.

(4) Determination of Weight Average Molecular Weight of PVDF Resin

The PVDF resin was dissolved in DMF at a concentration of 1.0 mg/ml to obtain a sample solution. 50 ml of the sample solution was used to perform gel permeation chromatography (GPC) determination under the following conditions to obtain the weight average molecular weight (PMMA conversion).

Device: HLC-8220GPC (Tosoh Corporation)

Column: Shodex KF-606M, KF-601

Mobile phase: 0.6 ml/min DMF

Detector: Differential refractive index detector

(5) Gurley Air Permeability Value

A 100 mm×100 mm separator sample with a porous film was cut, and tested using a Gurley 4110N air permeability tester (USA) under a 100 cc test air pattern. The time at which all of the test air passed through the separator sample with the porous film was recorded as a Gurley value. The Gurley value of the porous film was a value obtained by subtracting the Gurley value of the separator without the porous film (i.e., a pure porous substrate) from the Gurley value of the separator with the porous film.

(6) Peel Strength Between Porous Substrate and Porous Layer

An adhesive tape (model: 550R-12, Scotch) having a width of 12 mm and a length of 15 cm was attached to the surface of the porous layer on a side of the separator. The separator was cut so that its width and length were in consistent with the width and length of the adhesive tape to prepare a test sample. When the adhesive tape was attached to the separator, the length direction was aligned with the machine direction (MD) of the separator. It is to be noted that the adhesive tape is used as a support for peeling off the porous layer on the side.

The test sample was placed in an atmosphere at a temperature of 23±1° C. and a relative humidity of 50±5% for 24 hours or more, and the following measurement was performed in the same atmosphere.

The adhesive tape was peeled off with the porous layer immediately below the adhesive tape by about 10 cm, so that a laminate (1) of the adhesive tape and the porous layer was separated from a laminate (2) of the porous substrate and a porous layer on the other side by about 10 cm. An end of the laminate (1) was fixed to an upper gripper of TENSILON (RTC-1210A, Orientec Corp.), and an end of the laminate (2) was fixed to a lower gripper of TENSILON. The test sample was suspended in the gravity direction, so that the stretching angle (the angle of the laminate (1) with respect to the test sample) becomes 180°. The laminate (1) was stretched at a stretching speed of 20 mm/min, and the load when the laminate (1) was peeled from the porous substrate was measured. Loads from 10 mm to 40 mm after the start of the measurement were taken at an interval of 0.4 mm and the average thereof was taken as the peel strength.

(7) Bonding Strength

A test was performed with reference to the requirements of GB/T 2792.

1) A4 papers and separators were stacked together in an order of A4 paper/separator/separator/A4 paper, wherein the separator coating was opposite to the separator coating;

2) the stacked A4 papers and separators were subjected to thermoplastic treatment at a temperature of 100° C.; and

3) the separator after thermoplastic treatment was cut into elongated strips of 200 mm in length and 25 mm in width, a distance between clamps was (100±5) mm, and a test speed was (50±10) mm/min.

(8) Thermal Shrinkage

A test was performed with reference to the requirements of GB/T12027-2004.

1) A separator having a size of 15*15 cm was cut, the longitudinal and transverse directions were marked on a surface of the separator, and lengths of a sample in the longitudinal and transverse directions were measured with a ruler, respectively;

2) lengths of the sample in the longitudinal and transverse directions were measured with a ruler, respectively;

3) the sample was spread in a clamp and then placed in an oven at a temperature of 130° C. for 60 min;

4) after heating, the sample was taken out. After the temperature was restored to room temperature, the marked lengths in the longitudinal and transverse directions were measured again, respectively. The shrinkage was calculated according to the following formula, and the average value of several samples was taken as the shrinkage.

$$Δ L = \frac{L - {L}_{0}}{{L}_{0}} \qquad Δ T = \frac{T - {T}_{0}}{{T}_{0}}$$

ΔL—thermal shrinkage of the sample in the longitudinal direction, expressed in %;

L₀—the length of the sample in the longitudinal direction before heating, in millimeters (mm);

L—the length of the sample in the longitudinal direction after heating, in millimeters (mm);

ΔT—thermal shrinkage of the sample in the transverse direction, expressed in %;

T₀—the length of the sample in the transverse direction before heating, in millimeters (mm);

T—the length of the sample in the transverse direction after heating, in millimeters (mm).

(9) Puncture Strength of Separator

A flaky sample was prepared, fixed under a test clamp, and punctured on a puncture tester using a puncture needle having a diameter of 1 mm at a speed of 50 mm/min through a high-speed tensile machine and a puncture clamp. A top puncture force F was determined after data stabilization to calculate the puncture strength (in gf) as F/9.8*1000.

### Example 1

Based on 100 parts by weight of a coatable slurry, 3 parts by weight of PVDF resin having a weight average molecular weight of 900,000-1.1 million, 2 parts by weight of PVDF resin having a weight average molecular weight of 400,000-500,000, and 7.5 parts by weight of Al₂O₃ particles were added into a dimethylacetamide (DMAC)/water dispersion system (with the water content of 2 wt %), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is 5.36 μm, and the total surface density of the coatings on both sides is 7.24 g/m².

### Example 2

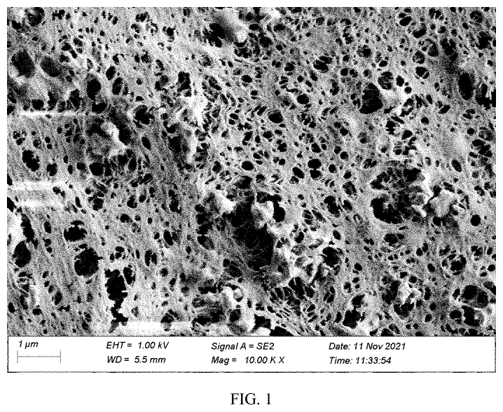

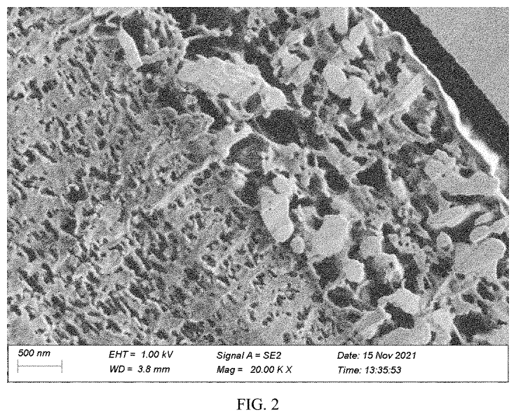

Based on 100 parts by weight of a coatable slurry, 3 parts by weight of PVDF resin having a weight average molecular weight of 900,000-1.1 million, 1.5 parts by weight of PVDF resin having a weight average molecular weight of 400,000-500,000, and 7.5 parts by weight of Al₂O₃ particles were added into dimethylacetamide (DMAC), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is 3.4 μm, and the total surface density of the coatings on both sides is 4.92 g/m². The apparent morphology of the separator is shown in FIG. 1, and the cross-sectional morphology of the separator is shown in FIG. 2.

### Example 3

Based on 100 parts by weight of a coatable slurry, 2 parts by weight of PVDF resin having a weight average molecular weight of 900,000-1.1 million, 3 parts by weight of PVDF resin having a weight average molecular weight of 400,000-500,000, and 7.5 parts by weight of Al₂O₃ particles were added into dimethylacetamide (DMAC), and dissolved at 50° C. for about 3 hours to form an adhesive. Both surfaces of a polyethylene porous substrate (a thickness of 7 μm, a porosity of 35%, an average pore size of 70 nm, and a puncture strength of 370 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is 4.44 μm, and the total surface density of the coatings on both sides is 5.14 g/m².

### Example 4

Based on 100 parts by weight of a coatable slurry, 2 parts by weight of PVDF resin having a weight average molecular weight of 900,000-1.1 million, 3 parts by weight of PVDF resin having a weight average molecular weight of 400,000-500,000, and 7.5 parts by weight of Al₂O₃ particles were added into dimethylacetamide (DMAC), and dissolved at 50° C. for about 3 hours to form an adhesive. Both surfaces of a polyethylene porous substrate (a thickness of 7 μm, a porosity of 35%, an average pore size of 70 nm, and a puncture strength of 370 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is controlled to be 6.6 μm, and the total surface density of the coatings on both sides is controlled to be 7.2 g/m² compared with Example 3.

### Example 5

Compared with Example 1, a ratio of DMAC to water in the coagulating bath was 6:4. The total thickness of the resulting coatings on both sides is 4.44 μm, and the total surface density of the coatings on both sides is 5.14 g/m².

### Example 6

Compared with Example 1, a ratio of DMAC to water in the coagulating bath was 4:6. The total thickness of the resulting coatings on both sides is 5.48 μm, and the total surface density of the coatings on both sides is 5.08 g/m².

### Example 7

Compared with Example 1, a ratio of DMAC to water in the coagulating bath was 3:7. The total thickness of the resulting coatings on both sides is 4.92 μm, and the total surface density of the coatings on both sides is 5.16 g/m².

### Example 8

Compared with Example 2, the drying temperature was controlled at 70° C. The total thickness of the resulting coatings on both sides is 3.4 μm, and the total surface density of the coatings on both sides is 5.32 g/m².

### Example 9

Compared with Example 2, the drying temperature was controlled at 85° C. The total thickness of the resulting coatings on both sides is 3.72 μm, and the total surface density of the coatings on both sides is 5.06 g/m².

### Example 10

Compared with Example 2, the drying temperature was controlled at 100° C. The total thickness of the resulting coatings on both sides is 4.16 μm, and the total surface density of the coatings on both sides is 5.68 g/m².

### Example 11

Based on 100 parts by weight of a coatable slurry, 0.6 part by weight of PVDF resin having a weight average molecular weight of 900,000-1.1 million, and 4.2 parts by weight of PVDF resin having a weight average molecular weight of 400,000-500,000 were added into dimethylacetamide (DMAC), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is controlled to be 2.0 μm, and the total surface density of the coatings on both sides is controlled to be 1.4 g/m² compared with Example 3.

### Example 12

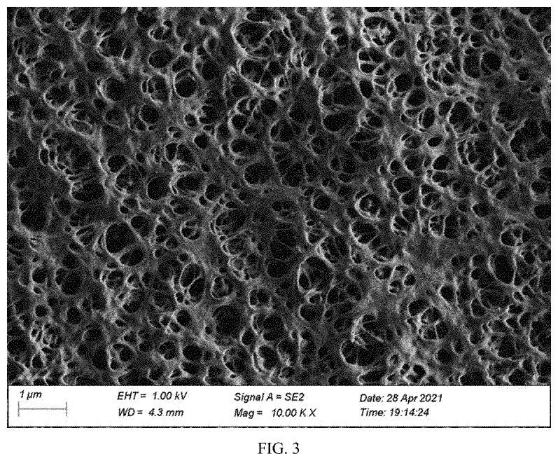

Based on 100 parts by weight of a coatable slurry, 0.6 part by weight of PVDF resin having a weight average molecular weight of 900,000-1.1 million, and 4.2 parts by weight of PVDF resin having a weight average molecular weight of 400,000-500,000 were added into dimethylacetamide (DMAC), and dissolved at 50° C. for about 3 hours to form an adhesive. Both surfaces of a single-sided ceramic-coated polyethylene porous substrate (a total thickness of coated films being 9 μm, a thickness of a ceramic layer being 2 μm, and a puncture strength of 470 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is controlled to be 1.6 μm, and the total surface density of the coatings on both sides is controlled to be 1.12 g/m² compared with Example 3. The surface morphology of the separator is shown in FIG. 3.

### Example 13

Based on 100 parts by weight of a coatable slurry, 1.2 parts by weight of PVDF resin having a weight average molecular weight of 900,000-1.1 million, and 3.6 parts by weight of PVDF resin having a weight average molecular weight of 400,000-500,000 were added into dimethylacetamide (DMAC), and dissolved at 50° C. for about 3 hours to form an adhesive. Both surfaces of a single-sided ceramic-coated polyethylene porous substrate (a total thickness of coated films being 9 μm, a thickness of a ceramic layer being 2 μm, and a puncture strength of 470 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is controlled to be 1.2 μm, and the total surface density of the coatings on both sides is controlled to be 0.936 g/m² compared with Example 3.

### Comparative Example 1

Based on 100 parts by weight of a coatable slurry, 3 parts by weight of PVDF resin having a weight average molecular weight of 900,000-1.1 million, 1 part by weight of PVDF resin having a weight average molecular weight of 200,000-500,000, and 7.5 parts by weight of Al₂O₃ particles were added into dimethylacetamide (DMAC), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is 2.88 μm, and the total surface density of the coatings on both sides is 4.2 g/m².

### Comparative Example 2

Based on 100 parts by weight of a coatable slurry, 3 parts by weight of PVDF resin having a weight average molecular weight of 900,000-1.1 million, 1 part by weight of PVDF resin having a weight average molecular weight of 200,000-500,000, and 10 parts by weight of Al₂O₃ particles were added into dimethylacetamide (DMAC), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is 4.44 μm, and the total surface density of the coatings on both sides is 5.64 g/m².

### Comparative Example 3

Based on 100 parts by weight of a coatable slurry, 1.6 parts by weight of PVDF resin having a weight average molecular weight of 900,000-1.1 million, 2.4 parts by weight of PVDF resin having a weight average molecular weight of 200,000-500,000, and 7.5 parts by weight of Al₂O₃ particles were added into dimethylacetamide (DMAC), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is 4.48 μm, and the total surface density of the coatings on both sides is 5.06 g/m².

### Comparative Example 4

Based on 100 parts by weight of a coatable slurry, 1.6 parts by weight of PVDF resin having a weight average molecular weight of 900,000-1.1 million, 2.4 parts by weight of PVDF resin having a weight average molecular weight of 200,000-500,000, and 7.5 parts by weight of Al₂O₃ particles were added into a dimethylacetamide (DMAC)/water dispersion system (with the water content of 6 wt %), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is 4.0 μm, and the total surface density of the coatings on both sides is 4.6 g/m².

### Comparative Example 5

Based on 100 parts by weight of a coatable slurry, 2 parts by weight of PVDF resin having a weight average molecular weight of 900,000-1.1 million, 3 parts by weight of PVDF resin having a weight average molecular weight of 200,000-500,000, and 7.5 parts by weight of Al₂O₃ particles were added into a dimethylacetamide (DMAC)/water dispersion system (with the water content of 6 wt %), and dissolved at 50° C. for about 3 hours to form an adhesive. Both surfaces of a polyethylene porous substrate (a thickness of 9 μm, a porosity of 35%, an average pore size of 70 nm, and a puncture strength of 450 gf) were coated with a slurry for forming a porous coating by a gravure roller at 23° C. under a relative humidity of 20%, and the resulting coatings were solidified by dimethylacetamide/water coagulating liquid (a ratio of DMAC to water in a coagulating bath was 5:5), washed with purified water, and dried at 80° C. to manufacture a separator having porous coatings. The total thickness of the resulting coatings on both sides is controlled to be 4.96 μm, and the total surface density of the coatings on both sides is controlled to be 5.74 g/m² compared with Example 4.

### Comparative Example 6

Compared with Example 1, a ratio of DMAC to water in the coagulating bath was 8:2. The total thickness of the resulting coatings on both sides is 4.48 μm, and the total surface density of the coatings on both sides is 5.32 g/m².

### Comparative Example 7

Compared with Example 2, the drying temperature was controlled at 55° C. The total thickness of the resulting coatings on both sides is 3.4 μm, and the total surface density of the coatings on both sides is 4.62 g/m².

Table 1 shows the related performance indexes of the separators in Examples 1-13 and Comparative examples 1-7. Thus it can be seen that although there are a number of influencing factors, the coatings have more excellent bonding performance to positive electrodes, high temperature dimensional stability and good air permeability when the coatings have a thickness within a certain range and meet the two conditions that the bonding strength (N/m)/coating air permeability increment (s/100 cc) is greater than or equal to 0.25 and the bonding strength (N/m)/the surface density per unit coating (g/m²/μm) is greater than or equal to 10, thereby resulting in good electrical performance of the corresponding lithium batteries.

Unless expressly excluded or otherwise limited, each literature cited herein, including any cross-reference or related patents or patent applications, and any patent application or patent of which the priority or benefit is claimed in this application, is hereby incorporated by reference in its entirety. Reference to any literature is not an admission that it is the prior art of any of the present disclosure disclosed or protected by the claims herein, or an admission that it is by itself or in combination with any one or more of the references to propose, suggest or disclose any such disclosure. Furthermore, where any meaning or definition of a term in the present disclosure is inconsistent with any meaning or definition of the same term in the documents incorporated by reference, it shall be subject to the meaning or definition assigned to the term in the present disclosure.

TABLE 1
Related performance indexes of separators in Examples 1-13 and Comparative
examples 1-4

| | | | | | | | Bonding | |
|---|---|---|---|---|---|---|---|---|
| | | | | | | Coating | strength/ | |
| | Coating air | | | Thermal | | surface | surface | Bonding |
| | permeability | Peel | Bonding | shrinkage | | density/ | density | strength/ |
| | increment | strength | strength | MD | TD | coating | per unit | coating air |
| No. | (s/100 cc) | (N/m) | (N/m) | (%) | (%) | thickness | coating | permeability |
| 1 | 58.25 | 404 | 15.23 | 4.5 | 2.1 | 1.35 | 11.28 | 0.26 |
| 2 | 47.25 | 450 | 15.90 | 4.7 | 2.2 | 1.45 | 10.99 | 0.34 |
| 3 | 47.25 | 258 | 21.33 | 4.5 | 2 | 1.16 | 18.42 | 0.45 |
| 4 | 43 | 49 | 16 | 4.5 | 1.7 | 1.09 | 14.67 | 0.37 |
| 5 | 47.25 | 258 | 21.22 | 4.5 | 2 | 1.16 | 18.33 | 0.45 |
| 6 | 47.75 | 242 | 16.89 | 4.8 | 1.8 | 0.93 | 18.22 | 0.35 |
| 7 | 45.5 | 245 | 14.83 | 5 | 2 | 1.05 | 14.14 | 0.33 |
| 8 | 47.25 | 450 | 15.90 | 4.5 | 2.1 | 1.45 | 10.99 | 0.34 |
| 9 | 45.75 | 376 | 17.25 | 4.2 | 2.2 | 1.36 | 12.68 | 0.38 |
| 10 | 51.75 | 444 | 16.30 | 4 | 1.7 | 1.37 | 11.94 | 0.31 |
| 11 | 38 | 189 | 10.02 | 10 | 9 | 0.76 | 17.33 | 0.34 |
| 12 | 40.1 | 189 | 10.51 | 1.7 | 1.1 | 0.76 | 17.33 | 0.26 |
| 13 | 45.10 | 192 | 15.31 | 1.7 | 1.2 | 0.78 | 19.70 | 0.33 |
| D1 | 39.75 | 354 | 13.76 | 5.3 | 2.4 | 1.46 | 9.44 | 0.35 |
| D2 | 56.5 | 182 | 9.80 | 4.7 | 2 | 1.27 | 7.72 | 0.17 |
| D3 | 32 | 27 | 7.5 | 4.7 | 1.8 | 1.13 | 6.64 | 0.23 |
| D4 | 27.5 | 20 | 6.2 | 4.8 | 1.7 | 1.15 | 5.39 | 0.23 |
| D5 | 37 | 15 | 9.3 | 4.7 | 1.7 | 1.16 | 8.04 | 0.25 |
| D6 | 75.61 | 201 | 15.73 | 4.8 | 1.8 | 1.19 | 13.25 | 0.21 |
| D7 | 48.5 | 386 | 13.07 | 4.7 | 2.3 | 1.36 | 9.62 | 0.27 |

Table 1: Related performance indexes of separators in Examples 1-13 and Comparative examples 1-7

1. A lithium battery separator comprising a porous PVDF-based resin coating, wherein the porous PVDF-based resin coating is located on at least one surface of a base film or a ceramic-coated film, and the porous PVDF-based resin coating on a single side has a thickness of 0.5-3.5 has a ratio of a bonding strength (N/m) to coating air permeability increment (s/100 cc) of greater than or equal to 0.25, and a ratio of a bonding strength (N/m) to a surface density per unit coating (g/m²/μm) of greater than or equal to 10.

2. The lithium battery separator according to claim 1, wherein PVDF-based resin in the porous PVDF-based resin coating comprises high molecular weight PVDF and low molecular weight PVDF, wherein the high molecular weight PVDF has a weight average molecular weight of 800,000-1,200,000, the low molecular weight PVDF has a weight average molecular weight of 200,000-500,000, and a weight ratio of the high molecular weight PVDF to the low molecular weight PVDF is 7:1 to 1:7.

3. The lithium battery separator according to claim 1, wherein the porous PVDF-based resin coating further comprises inorganic particles, and the content of the inorganic particles is 40-80 wt % based on a total weight of the porous PVDF-based resin coating.

4. The lithium battery separator according to claim 3, wherein the water content of its slurry is less than 5 wt % during preparation of the porous PVDF-based resin coating.

5. The lithium battery separator according to claim 4, wherein the water content of a coagulating bath is 30 wt %-70 wt % during preparation of the porous PVDF-based resin coating.

6. The lithium battery separator according to claim 5, wherein drying is carried out at a temperature of 60-100° C. during preparation of the porous PVDF-based resin coating.

7. A preparation method for the lithium battery separator comprising the porous PVDF-based resin coating according to claim 1, comprising the specific steps of:
step 1: dispersing PVDF-based resin into a solvent to form a coatable slurry, wherein the solvent comprises a good solvent, and the water content of the slurry on the whole is less than 5 wt %; and
step 2: coating at least one surface of a base film with the coatable slurry, dipping in a coagulating bath at room temperature for solidifying the resulting coating to form the porous PVDF-based resin coating, cleaning, and drying to obtain the lithium battery separator;
wherein the water content of the coagulating bath is 30 wt %-70 wt %, and the drying is carried out at a temperature of 60° C.-100° C.

8. The preparation method according to claim 7, wherein the PVDF-based resin comprises high molecular weight PVDF and low molecular weight PVDF, wherein the high molecular weight PVDF has a weight average molecular weight of 800,000-1,200,000, the low molecular weight PVDF has a weight average molecular weight of 200,000-500,000, and a weight ratio of the high molecular weight PVDF to the low molecular weight PVDF is 7:1 to 1:7.

9. The preparation method according to claim 7, wherein inorganic particles are further involved in the specific step of dispersing PVDF-based resin into a solvent to form a coatable slurry in the step 1, and the content of the inorganic particles is 40-80 wt % based on a total weight of the porous PVDF-based resin coating.

10. A lithium battery, comprising a positive electrode, a negative electrode, a non-aqueous electrolyte, and the lithium battery separator according to claim 1.

11. A lithium battery, comprising a positive electrode, a negative electrode, a non-aqueous electrolyte, and the lithium battery separator according to claim 2.

12. A lithium battery, comprising a positive electrode, a negative electrode, a non-aqueous electrolyte, and the lithium battery separator according to claim 3.

13. A lithium battery, comprising a positive electrode, a negative electrode, a non-aqueous electrolyte, and the lithium battery separator according to claim 4.

14. A lithium battery, comprising a positive electrode, a negative electrode, a non-aqueous electrolyte, and the lithium battery separator according to claim 5.

15. A lithium battery, comprising a positive electrode, a negative electrode, a non-aqueous electrolyte, and the lithium battery separator according to claim 6.

16. A preparation method for the lithium battery separator comprising the porous PVDF-based resin coating according to claim 2, comprising the specific steps of:
step 1: dispersing PVDF-based resin into a solvent to form a coatable slurry, wherein the solvent comprises a good solvent, and the water content of the slurry on the whole is less than 5 wt %; and
step 2: coating at least one surface of a base film with the coatable slurry, dipping in a coagulating bath at room temperature for solidifying the resulting coating to form the porous PVDF-based resin coating, cleaning, and drying to obtain the lithium battery separator;
wherein the water content of the coagulating bath is 30 wt %-70 wt %, and the drying is carried out at a temperature of 60° C.-100° C.

17. A preparation method for the lithium battery separator comprising the porous PVDF-based resin coating according to claim 3, comprising the specific steps of:
step 1: dispersing PVDF-based resin into a solvent to form a coatable slurry, wherein the solvent comprises a good solvent, and the water content of the slurry on the whole is less than 5 wt %; and
step 2: coating at least one surface of a base film with the coatable slurry, dipping in a coagulating bath at room temperature for solidifying the resulting coating to form the porous PVDF-based resin coating, cleaning, and drying to obtain the lithium battery separator;
wherein the water content of the coagulating bath is 30 wt %-70 wt %, and the drying is carried out at a temperature of 60° C.-100° C.

18. A preparation method for the lithium battery separator comprising the porous PVDF-based resin coating according to claim 4, comprising the specific steps of:
step 1: dispersing PVDF-based resin into a solvent to form a coatable slurry, wherein the solvent comprises a good solvent, and the water content of the slurry on the whole is less than 5 wt %; and
step 2: coating at least one surface of a base film with the coatable slurry, dipping in a coagulating bath at room temperature for solidifying the resulting coating to form the porous PVDF-based resin coating, cleaning, and drying to obtain the lithium battery separator;
wherein the water content of the coagulating bath is 30 wt %-70 wt %, and the drying is carried out at a temperature of 60° C.-100° C.

19. A preparation method for the lithium battery separator comprising the porous PVDF-based resin coating according to claim 5, comprising the specific steps of:
step 1: dispersing PVDF-based resin into a solvent to form a coatable slurry, wherein the solvent comprises a good solvent, and the water content of the slurry on the whole is less than 5 wt %; and
step 2: coating at least one surface of a base film with the coatable slurry, dipping in a coagulating bath at room temperature for solidifying the resulting coating to form the porous PVDF-based resin coating, cleaning, and drying to obtain the lithium battery separator;
wherein the water content of the coagulating bath is 30 wt %-70 wt %, and the drying is carried out at a temperature of 60° C.-100° C.

20. A preparation method for the lithium battery separator comprising the porous PVDF-based resin coating according to claim 6, comprising the specific steps of:
step 1: dispersing PVDF-based resin into a solvent to form a coatable slurry, wherein the solvent comprises a good solvent, and the water content of the slurry on the whole is less than 5 wt %; and
step 2: coating at least one surface of a base film with the coatable slurry, dipping in a coagulating bath at room temperature for solidifying the resulting coating to form the porous PVDF-based resin coating, cleaning, and drying to obtain the lithium battery separator;
wherein the water content of the coagulating bath is 30 wt %-70 wt %, and the drying is carried out at a temperature of 60° C.-100° C.
